(19) United States
(12) Patent Application Publication
(10) Pub. No.: US 2018/0153342 A1
(43) Pub. Date: Jun. 7, 2018

(54) HEATED BEVERAGE RECEPTACLE

(71) Applicant: GLOWSTONE LTD., Cheshire (JP)

(72) Inventor: Thomas GOSTELOW, Chester (GB)

(21) Appl. No.: 15/579,849

(22) PCT Filed: Jun. 3, 2016
(86) PCT No.: PCT/EP2016/062727

§ 371 Date: Dec. 5, 2017

(30) Foreign Application Priority Data
Jun. 5, 2015 (GB) 1509785.0
Dec. 11, 2015 (GB) 1521900.9

(51) Int. Cl. A47J 36/24; H05B 3/76

(52) U.S. Cl. CPC A47J 36/2466; H05B 3/76

(57) ABSTRACT

The invention relates to a beverage receptacle (10) comprising a receptacle body (12) and an active heating system (20). The receptacle body provides a chamber (16) for receiving a beverage and a cavity (18) which contains at least part of the active heating system. The active heating system comprises a heater (26) arranged to output heat to contents of the chamber, a rechargeable electrical energy store (32), a temperature sensor (44), control electronics (on a PCB 30) which control supply of electrical power from the electrical energy store to the heater in response to an output of the temperature sensor in order to regulate temperature of the contents of the chamber, and a wireless power receiver (38) for receiving electrical energy from a charging station to charge the electrical energy store without making an electrically conductive connection to the charging station.

The present invention relates to beverage receptacles provided with electrical heating.

Hot beverages such as tea and coffee are commonly served in cups or mugs and drunk over a period which can be quite protracted, during which the beverage loses heat to its surroundings and so cools. Many drinkers find cool or tepid beverages unpalatable and so discard their beverage part-drunk, or resort for example to re-heating it in a microwave oven.

It is known to incorporate an electrical heating system into a cup or mug. Examples are given in US2014/0305927, which discloses mugs and plates some of which incorporate a rechargeable battery to drive a heating element under the control of an electronic module.

Creating a beverage receptacle which is attractive to the user and also practical presents various challenges. In order to be re-usable the receptacle needs to survive repeated cycles of use and washing. External features relating to the heating system, including connectors for receiving power and switch or other user-operable control devices, are potentially vulnerable to damage as a result. This is particularly problematic if the receptacle is to be washed in a dishwasher. Also some users wish the external appearance of a conventional mug or cup to be preserved despite the provision of the heating system. Notwithstanding these requirements some form of control needs to be exercised over the heating system, at least in order to activate and deactivate it. Whatever form of energy store is used (e.g. a rechargeable battery) it will need to be recharged at intervals. Users may wish to adjust operating parameters such as a target beverage temperature. Users may wish to monitor their own beverage consumption.

The solution or alleviation of one or more of these problems is an object of the present invention.

According to the present invention there is provided a beverage receptacle comprising a receptacle body and an active heating system, wherein the receptacle body provides a chamber for receiving a beverage and a cavity which contains at least part of the active heating system, the active heating system comprising
a heater arranged to output heat to contents of the chamber,
a rechargeable electrical energy store,
a temperature sensor,

control electronics which control supply of electrical power from the electrical energy store to the heater in response to an output of the temperature sensor in order to regulate temperature of the contents of the chamber, and

a wireless power receiver for receiving electrical energy from a charging station to charge the electrical energy store without making an electrically conductive connection to the charging station.

Specific embodiments of the present invention will now be described, by way of example only, with reference to the accompanying drawings, in which:

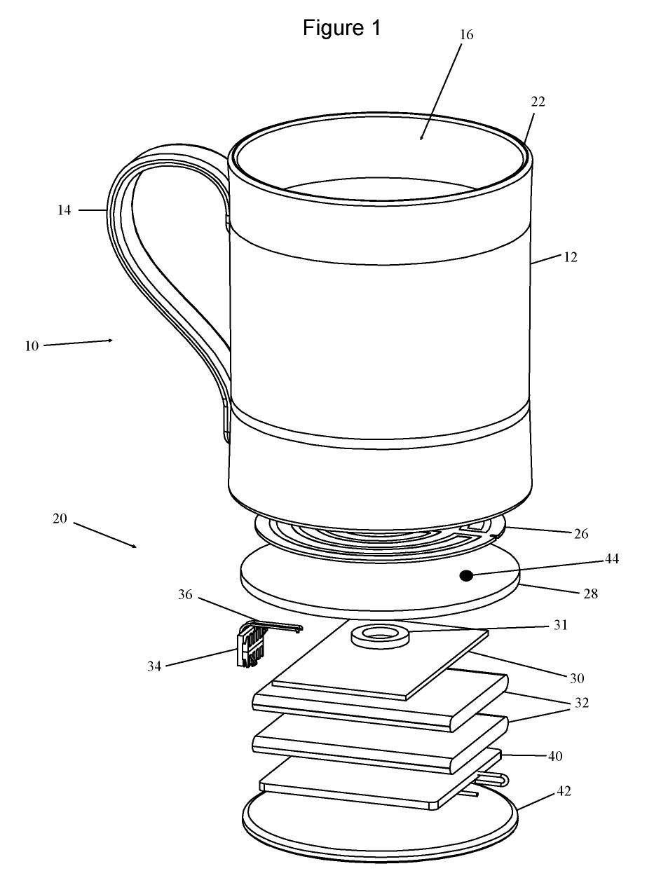

FIG. 1 is an exploded view of a beverage receptacle embodying the present invention;

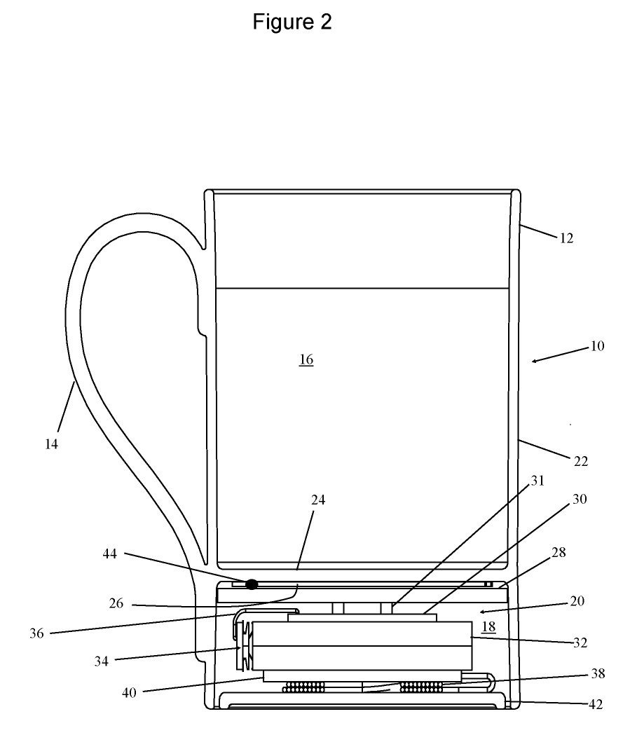

FIG. 2 is a section through the same beverage receptacle in a vertical plane;

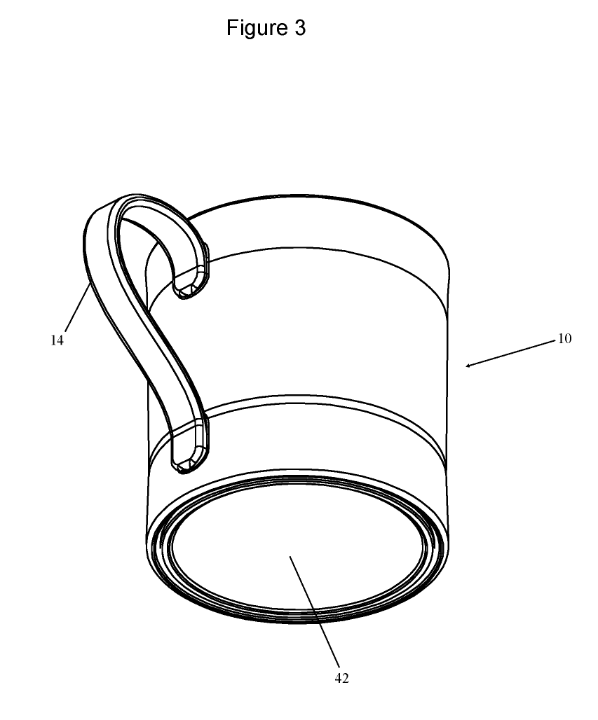

FIG. 3 is a perspective view of the same beverage receptacle from below and to one side;

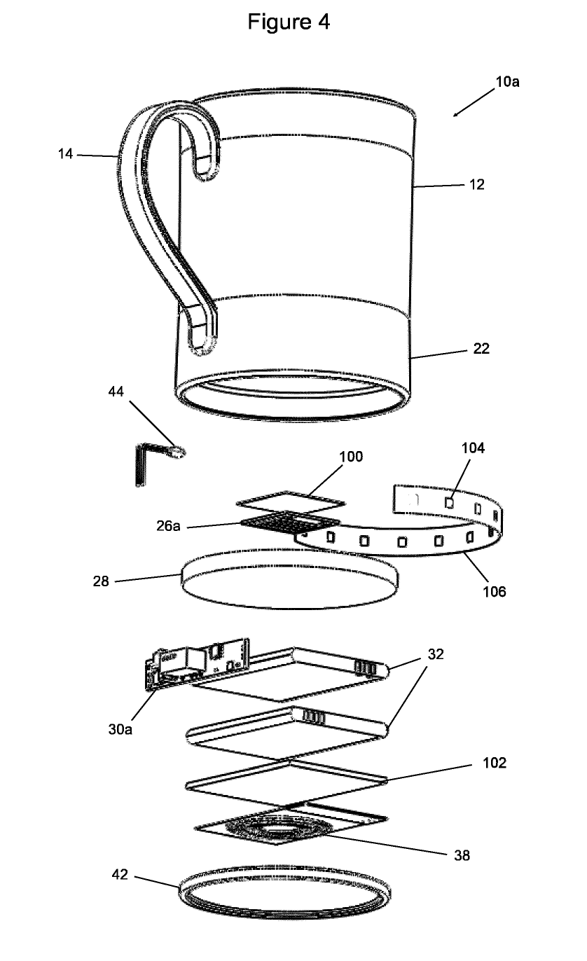

FIG. 4 is an exploded view of a second beverage receptacle embodying the present invention;

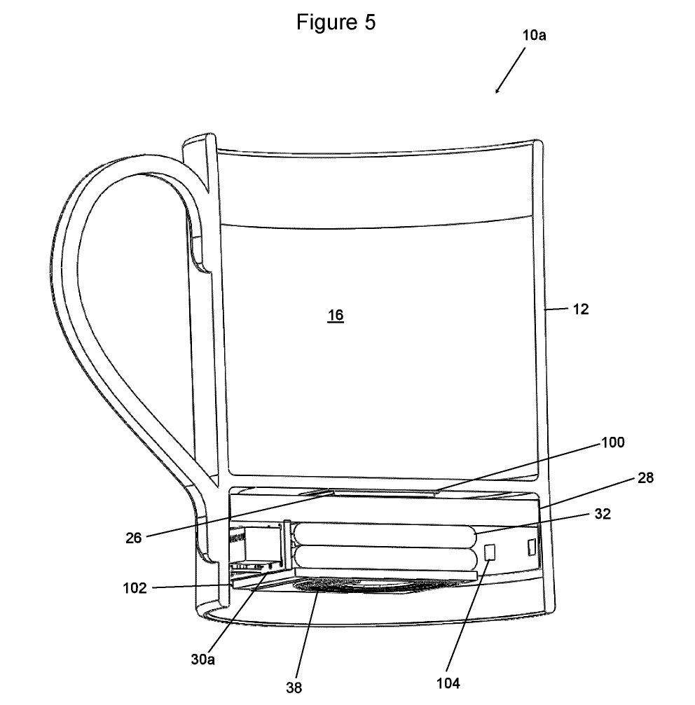

FIG. 5 shows a section through the second beverage receptacle in a vertical plane; and

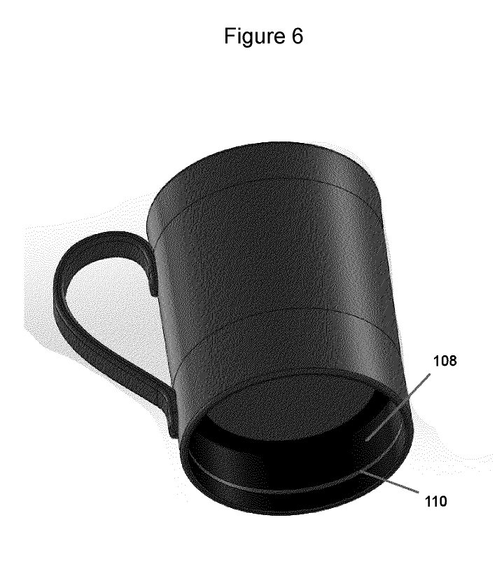

FIG. 6 is a view of the second beverage receptacle from beneath with certain components omitted.

### FIRST EMBODIMENT

The illustrated beverage receptacle 10 illustrated in FIGS. 1 to 3 is provided with active heating under electronic control in order to maintain a beverage at or about a predetermined temperature despite heat loss to the surroundings. It comprises a receptacle body 12, which in the present embodiment takes the form of a mug which has a handle 14 and which provides an open-topped chamber 16 for receiving the beverage. A range of materials can be used for the receptacle body 12. The illustrated example uses fine bone china but other types of fired ceramic such as earthenware, stoneware or porcelain may be adopted, as may any of a range of suitable plastics materials or metals or glass. This list is not exhaustive.

Some or all of the components used for the active heating function may be visible, as may internal display elements such as an indicator light to show whether the heating is active. This may be because the receptacle body 12 is transparent or translucent, e.g. being made of glass. Alternatively a light source may be provided which is able to transmit light through a seemingly opaque wall of the receptacle body 12, e.g. where this is formed of ceramic.

The receptacle body 12 forms an internal cavity 18 (see FIG. 2 in particular) containing components of an active heating system 20. In the illustrated example the receptacle body 12 comprises a cylindrical outer wall 22 whose interior space is divided in two by an integral chamber base wall 24. Above the chamber base wall 24 lies the open-topped chamber 16. Beneath it is the internal cavity 18.

A heating element 26 is disposed adjacent the chamber base wall 24 and in thermal contact with it, so that heat from the element 26 can be transmitted through the chamber base wall 24 to a beverage contained in the chamber 16. The heating element can take a variety of forms but a thick film resistive element is used in the present embodiment. A polyimide resistive heating element would also be particularly suitable. The heating element can be applied to the underside of the chamber base wall 24 to ensure intimate thermal contact. A heat transfer element is provided between the chamber base wall 24 and the heating element 26. This may take the form of a heat pad or thermal paste. It promotes conduction of heat from the heating element 26 to the chamber base wall 24 and so to the contents of the receptacle. Beneath the heating element 26 is an insulating plate 28 which is circular in the present embodiment to fit the cylindrical outer wall 22. Conductors (not shown) pass through or around the insulating plate 28 to transfer electrical power to the heating element 26. The periphery of the insulating plate 28 forms a seal against the wall 22 of the receptacle body 12 so that the heating element 26 is housed in an airtight chamber. The insulating plate 28 can prevent excessive transmission of heat from the heating element 26 and the beverage itself to electrical components of the active heating system 20.

In an alternative embodiment (not illustrated), the heating element 26 may be arranged in the chamber 16. In this case the heating element may be covered by a layer of enamel or glaze and thereby concealed.

Beneath the insulating plate 28 is a PCB (printed circuit board) 30. A spacer washer 31 is interposed between the insulating plate 28 and the PCB 30 creates a space between them for components carried on the PCB 30, and also helps to reduce undesirable heat transfer to it. The details of components carried on the PCB 30 are omitted from the drawing.

The PCB 30 sits atop an electrical energy store in the form of batteries 32. These are of rechargeable type. Any suitable battery (or indeed other suitable type of store of electrical energy which is currently available or which might become available in the future, such as super-capacitors) may be used. In the illustrated embodiment the batteries chosen are of lithium-ion type and two are provided. Purely by way of example, these batteries give a storage capacity of roughly 10 Wh (3.6 kJ). A battery designed for use in a mobile telephone is used in the present embodiment. A battery connector 34 conducts electrical power between circuitry carried upon the PCB 30 and the batteries themselves. The connector in the illustrated embodiment couples to the periphery of the battery and its power cables 36 lead to the face of the PCB 30.

Note that the term “battery” is adopted herein in accordance with common usage to refer to an electrical cell or cells—the item in question may have a single electrical cell or multiple cells.

The batteries 32, PCB 30 and battery connector 34 may be surrounded by a layer of shrink wrap or some other type of membrane, forming a single unit during assembly.

Beneath the batteries 32 is a wireless receiver 38 (see FIG. 2 in particular) carried on a substrate 40. The wireless receiver 38 receives electrical power from a remote charging station without any electrically conductive connection to it. This aspect will be explained further below. Electrical conductors (not shown) lead from the wireless receiver 38 to circuitry on the PCB 30 in order that power from the wireless receiver 38 can be directed to the batteries 32 to charge them.

Beneath the wireless receiver 38 is a closure part 42 formed in the present embodiment as a circular base plate. The periphery of the closure part 42 forms a seal with the receptacle body 12 so that the internal cavity 18 is itself sealed. The closure part 42 could be removable and provided with a peripheral seal, but more preferably it is permanently secured in place e.g. by means of an adhesive bond. In the present embodiment it is formed of the same material as the receptacle body 12 (fine bone china) and as a result the appearance of the beverage receptacle 10 is essentially that of a high quality bone china mug, with little to indicate to a user that it differs from a conventional mug. In certain embodiments, space within the internal cavity 18 around the components of the active heating system 20 is provided with filler material such as potting compound, which may serve (a) to assist in heat management (b) as a barrier against ingress of contaminants such as washing up water and (c) as protection against damage to the components due to physical impacts.

Temperature Regulation

The beverage receptacle 10 incorporates at least one temperature sensor whose output varies with the temperature of a beverage contained in the receptacle. In the illustrated embodiment temperature sensor 44 is in thermal contact with the underside of the chamber base wall 24. The heating element 26 may be formed in such a way as to leave a space around the temperature sensor 44 in order that its output reflects the temperature of the beverage—as a result of heat conducted from the beverage through the chamber base wall—more than that of the heating element 26. Thermal insulation may be provided to thermally isolate the temperature sensor 44 from the heating element 26.

Any suitable temperature sensor may be used. It may for example take the form of a thermocouple or solid state bandgap temperature sensor.

Power supplied to the heating element 26 is regulated in dependence upon temperature measured by the sensor 44 in order to regulate temperature of the beverage, under control of the circuitry carried upon the PCB 30. A microprocessor based controller may be provided for this purpose. The control may be carried out in the manner of a closed loop, with measured temperature as the controlled variable. Power may simply be switched on and off to regulate temperature. Alternatively power—or at least average power—may be adjusted. For example a square wave signal oscillating between zero and a drive voltage may be applied to the heating element, its mark space ratio being adjusted to vary power. This can be achieved in an energy efficient manner by well-known electronics. Pulse width modulation of the power may be employed.

Where power supplied to the heating element 26 is adjustable, a control strategy such as PID (proportional integral differential) control may be implemented. In this strategy the power is varied in dependence upon one or more of (a) the difference between measured temperature and a target temperature (b) the integral of this difference (so that applied power increases if a low temperature persists over time) and (c) the differential of this difference (so that a rapid change in measured temperature is countered by a larger change of power). Other suitable control strategies are known to the skilled person and may be adopted.

A target temperature to be maintained by the active heating system may be pre-set and/or may be adjustable by the user. For means of making such adjustment, see below.

However the control strategy need not necessarily be intended to maintain the beverage at a constant temperature. In other embodiments the strategy may be to allow the beverage to slowly cool over time. Thus for example it is estimated that a power input of the order of 25 to 30 Watts is needed to maintain a temperature in the region of 60-65 degrees Celsius, in a typical indoor environment. The heating element 26 may be provided with a somewhat lower power of the order of 15 to 20 Watts, so that cooling is greatly slowed but not altogether prevented. This may be a preferable approach to managing a limited battery capacity.

Power Transfer

The active heating system 20 receives electrical energy from a charging station without making an electrically conductive connection to it. This is achieved in the present embodiment by means of inductive coupling between the charging station and the wireless receiver 38. In the embodiment illustrated in FIGS. 1 to 3 the wireless receiver 38 is formed as a conductive coil. The charging station creates an alternating electromagnetic field that induces an electro-motive force (EMF) in the wireless receiver 38. This EMF is used to charge the energy store (batteries 32) and to power the heating element 26.

The use of a magnetic-resonance system for power transfer is especially preferred. Magnetic resonance technology, also referred to as resonant-inductive coupling or resonance charging, is known to the skilled person. The receiver 38 is designed to have a known resonant frequency (natural frequency) and the charging station has a transmitter coil that is driven with an AC signal at that frequency, providing energy transfer which can be advantageous in terms of efficiency and range.

Electronics carried upon the PCB 30 include battery management functionality for charging the batteries 32 in a safe and controlled manner and for controlling their discharge. A cut-off is typically included for deactivating the active heating system 20 when the batteries 32 reach a certain state of discharge.

Power may be transferred directly from the wireless receiver 38 to the heating element 26, e.g. in order to boost temperature in operation.

Charging Station

The use of a magnetic resonance system for power transfer makes it possible to transmit energy to the beverage receptacle 10 despite a considerable spatial separation between it and the charging station. The charging station can take a number of different forms in accordance with aspects of the present invention.

The charging station may be formed as a mat to be placed upon a horizontal surface such as a shelf or table. The mat may be suitable for supporting the beverage receptacle. It may for example take the form of a coaster upon which the beverage receptacle will be placed in use.

The charging station may be adapted for placement upon a shelf. In this way the beverage receptacle can be charged while it is stored. The charging station may for example have means for attachment to the underside of the shelf, such as a self-adhesive portion. It may have a slim line shape—e.g. that of a thin mat—in order to be inconspicuous in this setting.

Electrical power needs to be supplied to the charging station. Typically it will be adapted for connection to the mains electrical supply for this purpose. However the charging station may be adapted for electrical connection to other similarly formed charging stations, enabling multiple charging stations to be connected to one another or “daisy-chained” so that electrical power is transferred from one to another. A transformer unit separate from the main body of the charging station may be provided, in order that the connection to the charging station can be made through slim conductors at a voltage lower than that of the mains supply. Multiple charging stations may be driven from a single such transformer unit.

The charging station may be incorporated into another item. In particular, it may be incorporated in a shelf. The shelf may for example be of suitable type for substitution in an existing kitchen cabinet (such cabinets being subject to a degree of standardisation, so that a shelf could be provided capable of use with a range of kitchen cabinets). The shelf may incorporate transmitter coils and in some embodiments also the necessary electronics and power supply circuitry.

The charging station may be incorporated into an electrical device used to prepare a beverage. For example it may be incorporated into a coffee maker or kettle. The electrical device in question may be provided with some form of support to receive the beverage receptacle and support it in a suitable position to receive electrical energy from the charging station. However by use of magnetic-resonance power transfer the charging station may transmit power to the beverage receptacle remotely.

In some embodiments the charging station has no conductive connection to the mains electrical supply. Instead it serves as a booster, receiving energy inductively form a remote transmitter station and transferring it to the beverage receptacle.

In certain embodiments the charging station is able to switch its output power on and off automatically. It may do so in response to proximity of the beverage receptacle and/or in response to its state of charge. In a preferred embodiment the charging station periodically sends out a polling signal. If it receives a return signal indicative of the presence of the beverage receptacle then it commences transmission of power. Alternatively the charging station may be switched on and off manually.

In certain embodiments the charging station is able to switch its output power off upon detecting that the energy store of the beverage receptacle is charged. An indicator provided by the charging station—typically an optical indicator such as a coloured light—informs the user when the batteries 32 are charged for use and/or when charging is taking place. An indicator (e.g. in digital form) may also be provided on the charging station to show the level of charge of the batteries 32.

Control of the Active Heating System

The active heating system 20 typically needs to be activated and deactivated according to whether the beverage receptacle 10 is in use. This may be done automatically. It may be done in response to the output of the temperature sensor 44.

Thus for example the active heating system may be activated in response to a rapid rise in measured temperature (which is indicative of the beverage receptacle 10 being filled with a hot beverage). It may be deactivated in response to a change in measured temperature indicative of absence of liquid in the beverage container, such as a rapid warming of the sensor due to the absence of the thermal mass of the liquid.

Additionally or alternatively the active heating system may be configured to deactivate itself after a predetermined time interval. This time interval may be user adjustable.

The beverage receptacle may be provided with an accelerometer, inclinometer or other means of sensing movement and/or orientation, as a means of control of the active heating system. The type of miniature accelerometer widely known for use in smart telephones is used in the illustrated embodiment, being carried upon the PCB 30. Movements, gestures and/or impacts may thereby be used to give the user control over the active heating system. Specifically, the beverage receptacle may be programmed (or otherwise adapted) to switch off the active heating system when inverted. In this way it can be ensured that when the beverage receptacle is placed inverted in a dishwasher its major electrical components are deactivated, reducing their susceptibility to damage in the hostile environment of the dishwasher. The active heating system may be activated and/or deactivated in response to gestures and/or impacts. For instance a double tap of the beverage receptacle against some other object may serve as a signal from the user to deactivate the heater. A shake of the unit for say one second may be used to activate a wireless interface (as to which see below).

The beverage receptacle may be provided with a wireless interface. This may, without limitation, use a standard format such as NFC (near field communication), Bluetooth (UHF RF wireless data transfer standard), or a wireless LAN (local area network). Data transfer may be mono-directional—from a base station to the beverage receptacle, for the purpose of control of the latter—or bi-directional. By use of any of these communications standards, the beverage controller can interface with computing devices including smart phones, tablets, laptops and desk based personal computers as well as worn computer devices such as smart watches.

Control signals sent to the beverage receptacle through the wireless interface may include signals to activate and deactivate the active heating system and/or to adjust the target temperature of the active heating system and/or to adjust a period after which the active heating system will be automatically deactivated.

Information sent out by the beverage receptacle may include any of (a) current measured temperature (b) battery charge state (c) duration of activation.

By use of suitable software on a computing device (e.g. an app on a smartphone), the user can be provided with a range of data.

For example the number of beverages consumed—in a day or over some other period—may be inferred from the number of times that the device is activated. In this way for example coffee drinkers concerned to monitor their caffeine intake can be given an objective means of doing so. Data may be collected over some extended period and presented to the user in suitable form, such as a graph or other graphical representation of daily intake.

An alternative or additional means of exchanging commands and/or data with the beverage receptacle is by means of audio signals. The beverage receptacle may be provided with a microphone or other audio detector and programmed or otherwise adapted to respond to voice commands or other audio signals. Again, voice commands may include commands to activate and deactivate, and to change a target temperature. The beverage receptacle may additionally or alternatively be provided with a loudspeaker or other audio output device and a speech synthesiser in order to provide information such as battery state and measured temperature in spoken form.

The audio output device may supply other types of content. The beverage receptacle 10 may connect through its wireless interface to a media channel, enabling it to play music or other audio material. Additionally or alternatively it may output pre-recorded advertising material which may be stored in an onboard memory or streamed from a network.

### Second Embodiment

The second embodiment 10a of the invention depicted in FIGS. 4 to 6 is in many respects similar to that of FIGS. 1 to 3. Corresponding features have been given the same reference numerals throughout, except that certain features which are different in the two embodiments are given the suffix “a” in FIGS. 3 to 6.

Features that are similarly formed in the two embodiments will not be described again, beyond noting that like the first embodiment, the second beverage receptacle 10a has an electrically powered heating system comprising a heating element 26a driven from batteries 32 under the control of electronics carried on a circuit board 30a and based on signals from a temperature sensor 44, formed in this embodiment as a thermistor. Thermal separation between the heating element 26a and the electronics is provided by insulating plate 28.

The second beverage receptacle 10 represents a development of the first in several respects.

Whereas the first embodiment has a large circular heating element 26 covering much of the area of the chamber base wall 24, the second has a smaller centrally placed heating element 26a. This has proven preferable in that a smaller element can more easily and reliably be placed in strong thermal contact over its whole area with the base wall, which—being formed of china—is typically not entirely flat. Thermally conductive heat paste interposed between the heating element 26a and the chamber base wall is indicated at 100 in FIGS. 4 and 5. The localised heating provided by this relatively small element 26 can help to promote convective mixing of the beverage to distribute heat evenly through it.

The PCB 30a of the second embodiment sits on the edge of the batteries 32, which reduces the depth of the arrangement and facilitates direct solder connections to the battery terminals.

The substrate 102 for the wireless receiver 38 is a thermally insulating board.

The second embodiment includes an optical signalling system, which will now be described.

Optical Signalling System

In the illustrated beverage receptacles 10, 10a the components forming the active heating system are contained and concealed within the sealed internal cavity 18. While advantageous in many respects, this does create a challenge in signalling to the user the operational status of the heating system—is the system active, is the battery charged etc.

The inventor has found that even where the receptacle body 12 is formed of ceramic such as china, light from a source disposed within the internal cavity 18 can be seen from its exterior. In this way a light source can be used to provide the user with signals relating to status/operation of the active heating system.

In the second beverage receptacle 10a, the optical signalling system comprises multiple light sources formed as LEDs 104 disposed in the cavity 18 and carried upon a strip 106 running circumferentially about the interior wall of the cavity. The LEDs 104 project light onto the wall 22 of the receptacle body 12 and it is found that enough light passes through the wall 22 to produce a visual signal (a glow) which is clearly visible to the user even in bright daylight.

The wall 22 of the may be selectively provided with an opaque mask to localise the emitted light on the surface of the beverage receptacle 10a, contributing to an attractive appearance. This may be done with suitably opaque coverings such as paint or adhesive tape. Looking at FIG. 6, it can be seen that in the second beverage receptacle 10a the interior of the wall 22, within the cavity 18, carries an opaque paint in region 108 which prevents escape of light. This is selectively relieved to form a region through which light passes. In this example the region in question forms a circumferential stripe 110, so that when the LEDs 104 are lit the user sees an illuminated band running around the receptacle. The effect of the light emerging form the china is visually striking and attractive.

The optical signalling system can be used in a range of different ways to provide information to the user. Most simply it may be illuminated to indicate that the active heating system is operating.

Additionally or alternatively it may for example:
provide an indication of battery charge level, e.g. by illuminating a variable number of LEDs according to the state of charge, or by use of different colours, e.g. blue for a good state of charge blending to red for low battery level
provide a safety warning. For example if the mug is placed in a microwave oven, a microwave detector in the cavity 18 could be used to activate a visible warning signal
flash to indicate conditions such as low battery
provide a warning when the active heating system is shortly to shut down, e.g. five minutes before it does so
provide a signal—be it colour coded, or optical intensity modulated, of a current temperature setting or time setting
provide a signal indicating the detected temperature of the beverage
be remotely activated through a radio interface to help a user find the mug when lost, by making it glow (and a loudspeaker could be used to provide an audio signal for the same purpose)
serve to personalise the mug by enabling the user to select colour or other properties of the emitted light
enable a user to distinguish his/her receptacle form a number of similar ones (e.g. on a shelf in a workplace) by causing it to glow.

A light source such as the LEDs 104 in the cavity 18 can additionally or alternatively be used for decorative effect. For instance a mask may be used whose silhouette forms some visual design such as a word, shape, logo or emblem to be displayed on the wall or base of the receptacle. The mask may be in register with artwork on the exterior of the receptacle so that the emitted light compliments the artwork, e.g. by illuminating selected regions of it.

Capacitive Switches

The active heating system may be controlled through one or more non-contact switch(es), in particular capacitance switches, safely contained inside the internal cavity 18 and arranged to detect the proximity of a fingertip through the wall 22. A capacitance switch can be placed adjacent the wall 22 or base (closure part 42) to detect proximity of a fingertip indicative of a command from the user. The zone of sensitivity of the capacitance switch may be indicated by markings on the exterior of the beverage receptacle, so that the user may for example see circles on the base marked “ON”, “OFF” “HOTTER”, “COLDER” etc., touching which effects the relevant change to the system's operation.

Security

The beverage receptacle may incorporate a security device in order that a remote system is alerted if the cup is taken out of a certain area. In the present embodiment this takes the form of a wireless (e.g. radio frequency) tag which is detectable by a base station. If the tag is removed from the relevant area this is detected by the base station. Alternatively the base station may detect passage or presence of the tag in a defined area (e.g. the doorway of a coffee shop). In this way for example a coffee shop using the beverage receptacle 10 may protect against it being stolen.

The above described embodiments are presented by way of example and not limitation, the scope of the present invention being that determined by the accompanying claims. Many variants are possible. In particular, while the illustrated embodiment is a mug or cup, the beverage receptacle may instead take the form of a baby's bottle, with or without a teat or spout. In this case the beverage in question will typically be either expressed maternal milk or synthetic baby milk (often referred to as “formula milk”).

1. A beverage receptacle comprising a receptacle body and an active heating system, wherein the receptacle body provides a chamber for receiving a beverage and a cavity which contains at least part of the active heating system, the active heating system comprising
a heater arranged to output heat to contents of the chamber,
a rechargeable electrical energy store,
a temperature sensor,
control electronics which control supply of electrical power from the electrical energy store to the heater in response to an output of the temperature sensor in order to regulate temperature of the contents of the chamber, and
a wireless power receiver for receiving electrical energy from a charging station to charge the electrical energy store without making an electrically conductive connection to the charging station.

2. (canceled)

3. (canceled)

4. A beverage receptacle as claimed in claim 1 in which the rechargeable energy store comprises at least one rechargeable electrical battery and which further comprises battery management circuitry for supplying electrical power from the power receiver to the rechargeable electrical battery.

5. (canceled)

6. (canceled)

7. (canceled)

8. A beverage receptacle as claimed in claim 1 which is configured to activate the active heating system in response to a temperature change upon pouring a beverage into the chamber.

9. (canceled)

10. (canceled)

11. (canceled)

12. A beverage receptacle as claimed in claim 1 which further comprises any of (a) accelerometer and (b) another motion detection and (c) an inclinometer and (d) an orientation switch, and in which the control electronics are configured to perform any of (a) activation, (b) deactivation, or (c) adjustment of the active heating system in response to predetermined movement of, impact to, or inclination of the beverage receptacle.

13. A beverage receptacle as claimed in claim 12 which is configured to activate the active heating system in response to an impact or predetermined number of impacts.

14. (canceled)

15. (canceled)

16. A beverage receptacle as claimed in claim 1 further comprising a loudspeaker or other audio transducer for outputting audio signals to the user.

17. (canceled)

18. A beverage receptacle as claimed in claim 1 further comprising a wireless data interface.

19. (canceled)

20. (canceled)

21. (canceled)

22. A beverage receptacle as claimed in claim 18 which is configured to output data through the wireless interface.

23. (canceled)

24. A beverage receptacle as claimed in claim 18 which is configured to adjust a target beverage temperature for the active heating system based on a control input received through the wireless interface.

25. (canceled)

26. A beverage receptacle as claimed in claim 1 in which the active heating system is contained and sealed within the receptacle body without any feature of it being exposed to or visible from the exterior.

27. A beverage receptacle as claimed in claim 26 in which the cavity is closed by a lid, panel or other closure member which forms a seal against the receptacle body to prevent ingress of foreign matter to the cavity.

28. A beverage receptacle as claimed in claim 1 further comprising a light source disposed within the said cavity which emits light through the material of the receptacle body to provide a visible signal at its exterior.

29. A beverage receptacle as claimed in claim 28 in which the said material of the receptacle body is fired ceramic.

30. A beverage receptacle as claimed in claim 28 further comprising electronics which control the light source in accordance with at least one operating parameter of the active heating system in order to provide a user with a visual signal relating to the said parameter.

31. A beverage receptacle as claimed in claim 30 in which the intensity and/or output colour of the light source is variable to provide the user with information.

32. A beverage receptacle as claimed in claim 30 provided with multiple light sources at least some of which are independently illuminable to provide the user with information.

33. A beverage receptacle as claimed in claim 1 comprising at least one non-contact switch or sensor which is housed inside the cavity and is sensitive to application of a fingertip to the beverage receptacle's exterior.

34. A beverage receptacle as claimed in claim 33 in which the switch or sensor is a capacitive device.

35. (canceled)

36. (canceled)

37. (canceled)

38. (canceled)

39. A system comprising a beverage receptacle as claimed in claim 18 and a computing device programmed to exchange data with the beverage receptacle through the wireless interface.

40. (canceled)

41. A system as claimed in claim 39 in which the computing device is programmed to compile and display to the user data relating to beverage consumption over time, said data being inferred from operation of the active heating system.

42. (canceled)
